(19) United States
(12) Patent Application Publication
(10) Pub. No.: US 2017/0316083 A1
(43) Pub. Date: Nov. 2, 2017

(54) CONTENT DISTRIBUTION APPARATUS, CONTENT DISTRIBUTION SYSTEM, AND PROGRAM

(71) Applicant: Sharp Kabushiki Kaisha, Osaka (JP)

(72) Inventors: Masafumi OKIGAMI, Sakai City (JP); Takayuki OGAWA, Sakai City (JP)

(21) Appl. No.: 15/497,323

(22) Filed: Apr. 26, 2017

(30) Foreign Application Priority Data
Apr. 27, 2016 (JP) 2016-089814

(51) Int. Cl. G06F 17/30; G09G 5/12; G09G 3/00

(52) U.S. Cl. CPC G06F 17/30598; G06F 17/30817; G09G 5/12; G09G 3/004; G06F 17/3084; G06F 17/30023; G06F 17/30554; G06F 17/30265; G06F 17/3005; G09G 2380/06

(57) ABSTRACT

A content distribution apparatus generates a group of contents to be sent to a content display apparatus that can continuously display contents of the same attribute. When a first content is newly added to the group, the content distribution apparatus determines the attribute of the first content as the attribute of the group. When adding a second content to the group, if the attribute of the second content coincides with the attribute of the group, the content distribution apparatus adds the second content to the group. The content distribution apparatus sends a content included in the group to the content display apparatus.

### BACKGROUND

### 1. Field

The present disclosure relates to a content distribution apparatus and so forth that are connectable to a content display apparatus that can continuously display contents of the same attribute.

### 2. Description of the Related Art

A digital signage system that displays or reproduces still image contents or video contents by using a display apparatus is known. The digital signage system uses a large display apparatus, which is called an information display, as a content display apparatus for displaying or reproducing the contents. The content display apparatus is often installed in a place where people gather, such as stores, shopping malls, public facilities, and public institutions.

In the digital signage system, contents are distributed from a content distribution apparatus to the content display apparatus. Specifically, the content distribution apparatus generates a list (a group) of content files and distributes the content files included in the list to the content display apparatus via a network. The content display apparatus continuously displays the content files (contents).

The content display apparatus can display contents of the same attribute, but does not support display of contents of different attributes. For instance, if a content (an image content) whose attribute is an image (a still image) and a content (a video content) whose attribute is video coexist in a list, it is difficult for the content display apparatus to address the situation, such as judging the attributes of these contents. For this reason, the content distribution apparatus generates a list (a group) of content files of the same attribute and distributes the content files included in the list to the content display apparatus via a network.

Japanese Unexamined Patent Application Publication No. 2001-197244 describes a technique of managing files of the same attribute. If the attribute of a file to be registered in a folder does not coincide with the attribute of the folder, the technique described in Japanese Unexamined Patent Application Publication No. 2001-197244 displays a warning to the effect that registration of the file in the folder is not possible.

In the technique described in Japanese Unexamined Patent Application Publication No. 2001-197244, the attribute of a folder has to be set in advance. On the other hand, in the digital signage system, a content that is displayed by the content display apparatus is changed depending on the installation site of the content display apparatus or time. Thus, in the digital signage system, if the attribute of a list is set in advance, a content display apparatus for displaying an image content and a content display apparatus for displaying a video content have to be installed in the same installation site, for example.

Moreover, in the digital signage system, providing a content display apparatus for image contents and a content display apparatus for video contents increases the number of content display apparatuses and results in complicated management.

It is desirable to provide a content distribution apparatus and so forth that can distribute contents of the same attribute to a content display apparatus without setting an attribute in advance.

### SUMMARY

According to an aspect of the disclosure, there is provided a content distribution apparatus that is connectable to a content display apparatus that can continuously display contents of the same attribute, the content distribution apparatus including: a generating unit that generates a group of contents to be sent to the content display apparatus; an attribute determining unit that determines, when a first content is newly added to the group, the attribute of the first content as the attribute of the group; an adding unit that adds, when adding a second content to the group, the second content to the group if the attribute of the second content coincides with the attribute of the group; and a sending unit that sends a content included in the group to the content display apparatus.

According to an aspect of the disclosure, there is provided a content distribution system including: a content display apparatus that can continuously display contents of a same attribute; and a content distribution apparatus that is connectable to the content display apparatus, in which the content distribution apparatus includes a generating unit that generates a group of contents to be sent to the content display apparatus, an attribute determining unit that determines, when a first content is newly added to the group, an attribute of the first content as an attribute of the group, an adding unit that adds, when adding a second content to the group, the second content to the group if an attribute of the second content coincides with the attribute of the group, and a sending unit that sends a content included in the group to the content display apparatus.

According to an aspect of the disclosure, there is provided a program that is executed by a computer connectable to a content display apparatus that can continuously display contents of a same attribute, the program including: generating a group of contents to be sent to the content display apparatus; determining, when a first content is newly added to the group, an attribute of the first content as an attribute of the group; adding, when adding a second content to the group, the second content to the group if an attribute of the second content coincides with the attribute of the group; and sending a content included in the group to the content display apparatus.

### BRIEF DESCRIPTION OF THE DRAWINGS

FIG. 1 is a diagram for explaining the overall configuration in a first embodiment;

FIG. 2 is a diagram for explaining the overall configuration in the first embodiment;

FIG. 3 is a diagram for explaining the configuration of a content display apparatus in the first embodiment;

FIG. 4 is a diagram for explaining the configuration of a content distribution apparatus in the first embodiment;

FIG. 5 is a diagram for explaining a list of content files in the first embodiment;

FIG. 6 is an operation flow for explaining content display processing in the first embodiment;

FIG. 7 is an operation flow for explaining content distribution processing in the first embodiment;

FIG. 8 is an operation flow for explaining content file addition processing in the first embodiment;

FIG. 9 is a diagram for explaining an operation screen in the first embodiment;

FIG. 10 is a diagram for explaining the operation screen in the first embodiment;

FIG. 11 is a diagram for explaining the operation screen in the first embodiment;

FIG. 12 is a diagram for explaining the operation screen in the first embodiment;

FIG. 13 is a diagram for explaining the operation screen in the first embodiment;

FIG. 14 is a diagram for explaining the operation screen in the first embodiment;

FIG. 15 is a diagram for explaining the operation screen in the first embodiment;

FIG. 16 is an operation flow for explaining content file addition processing in a second embodiment;

FIG. 17 is a diagram for explaining an operation screen in the second embodiment;

FIG. 18 is an operation flow for explaining content file addition processing in a third embodiment;

FIG. 19 is an operation flow for explaining the content file addition processing in the third embodiment;

FIG. 20 is a diagram for explaining an operation screen in the third embodiment;

FIG. 21 is an operation flow for explaining content file addition processing in a fourth embodiment; and

FIG. 22 is a diagram for explaining an operation screen in the fourth embodiment.

### DESCRIPTION OF THE EMBODIMENTS

Hereinafter, embodiments of the present disclosure will be described in detail with reference to the drawings. The following description will be given by taking up, as an example, a content distribution system including a content distribution apparatus and a content display apparatus of the present disclosure. It goes without saying that the present embodiments are examples for explaining the present disclosure and the present disclosure is not limited to the descriptions of the embodiments.

### 1. First Embodiment

First, a first embodiment will be described. The first embodiment is an example in which a content is sent or distributed to a predetermined content display apparatus.

### [1.1 Overall Configuration]

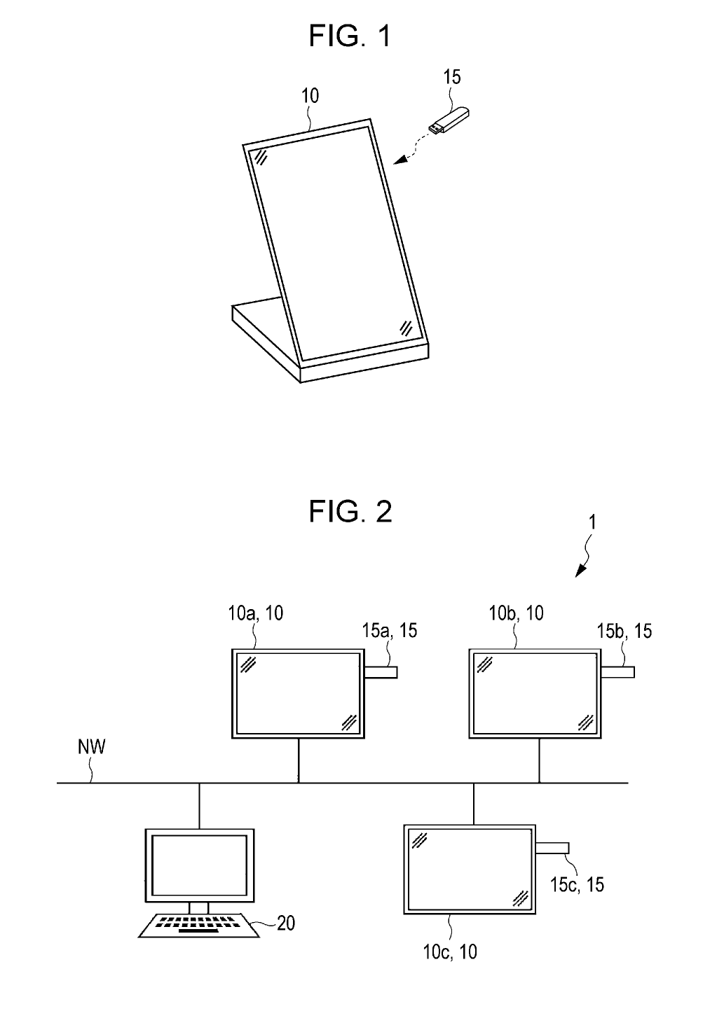

First, an overall configuration will be described with reference to FIGS. 1 and 2. FIG. 1 is a diagram for explaining the general outline of a content display apparatus. A content display apparatus 10 is configured with, for example, a large display. For instance, the content display apparatus 10 is a display apparatus provided with a liquid crystal display as a display apparatus thereof. Such a display is called an information display and often installed in a place where people gather, such as stores, shopping malls, public facilities, and public institutions.

The content display apparatus 10 is provided with a universal serial bus (USB) interface as an external interface (IF), for example. To the USB interface, various kinds of peripheral apparatuses can be connected. In the present embodiment, an external memory unit is connected to the USB interface. As the external memory unit, for example, a USB memory, an external HDD, an SSD, a memory card, and so forth can be used. FIG. 1 depicts a USB memory 15, which is insertable.

As the external IF, a card slot may be provided for an SD card, for example. That is, an interface corresponding to a peripheral apparatus which is to be connected is provided. The IF in the present embodiment is an interface to which at least the external memory unit can be connected.

FIG. 2 is a diagram depicting the whole of a content distribution system 1 including the content display apparatus 10 and a content distribution apparatus 20. The content distribution system 1 includes one or more than one content display apparatus 10. For example, in FIG. 2, as a plurality of content display apparatuses 10, content display apparatuses 10a, 10b, and 10c are connected to the content distribution apparatus 20 via a network NW. Moreover, each of a plurality of USB memories 15 is inserted into a corresponding one of the plurality of content display apparatuses 10. For instance, a USB memory 15a is connected to the content display apparatus 10a, a USB memory 15b is connected to the content display apparatus 10b, and a USB memory 15c is connected to the content display apparatus 10c.

The content distribution apparatus 20 is configured with a computer server. As a result of a content distribution program (a content distribution application) being executed on the computer server, the content distribution apparatus 20 is implemented. The content distribution apparatus 20 may be implemented by, for example, a tablet terminal or a smartphone if the tablet terminal or the smartphone can execute the content distribution program.

### [1.2 Functional Configuration]

Then, the functional configuration of each apparatus will be described with reference to the drawing.

### [1.2.1 Content Display Apparatus]

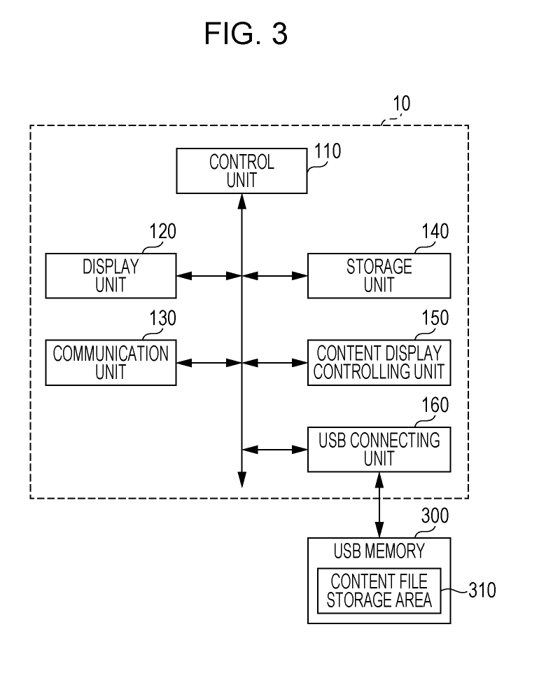

The functional configuration of the content display apparatus 10 will be described with reference to FIG. 3. As depicted in FIG. 3, the content display apparatus 10 includes a control unit 110, a display unit 120, a communication unit 130, a storage unit 140, a content display controlling unit 150, and a USB connecting unit 160.

The control unit 110 is a functional unit for controlling the whole of the content display apparatus 10. The control unit 110 implements various functions by reading and executing various programs which are stored in the storage unit 140 and is configured with a central processing unit (CPU), for example.

The display unit 120 is a functional unit for displaying contents. For instance, the display unit 120 is configured with a liquid crystal display or an organic EL display. It goes without saying that the display unit 120 may be a projecting apparatus such as a projector or the contents may be displayed on an external display apparatus by using HDMI®.

The communication unit 130 is a functional unit with which the content display apparatus 10 communicates with the content distribution apparatus 20. For example, the communication unit 130 is implemented by a network interface card (NIC) that is used in a wired/wireless LAN or a communication module that is connectable to the 3G/LTE line. Moreover, near field communication such as Bluetooth® or ZigBee may be used.

The storage unit 140 is a functional unit that stores various programs and various kinds of data which are used by the content display apparatus 10 to operate. The storage unit 140 is configured with, for example, a semiconductor memory or a hard disk drive (HDD).

The content display controlling unit 150 is a functional unit that performs control of displaying contents on the display unit 120. For instance, the content display controlling unit 150 is a functional unit that performs control of sequentially displaying contents (for example, performs display control of displaying image data, which is a still image, like a slide show or continuously reproducing video data).

Specifically, the content display controlling unit 150 performs control of sequentially displaying contents as a result of a program called a media player being executed. In so doing, the content display controlling unit 150 accesses a USB memory 300 to determine whether or not a content file is stored in a specific folder (an “AutoPlay folder”) of the USB memory 300.

If a content file is stored in the “AutoPlay folder”, the content display controlling unit 150 automatically reads the content file and displays the content. In so doing, the content display controlling unit 150 reads the content file in order of file number and displays the content.

Incidentally, the folder may have another name or a particular folder does not have to be designated. For example, if a content file is stored in the USB memory 300, the content display controlling unit 150 may automatically display the content.

The USB connecting unit 160 is a functional unit for connection with a USB apparatus. For instance, the USB connecting unit 160 is configured as an interface complying with USB 2.0/3.0/3.1. In the present embodiment, the description will be given by taking up the USB apparatus as an example, but the USB connecting unit 160 may be any interface that is connectable to an external apparatus. For instance, the USB connecting unit 160 may be an interface complying with bus standards such as RS-232C, IEEE1394, Lightning, Thunderbolt, and SCSI.

The USB memory 300 is connected as an external memory unit via the USB connecting unit 160. The USB memory here refers to the USB memory 15 depicted in FIG. 1. In the present embodiment, the USB memory will be described as an example of the external memory unit, but the external memory unit may be any of various kinds of memory units such as an external HDD and an SSD. Moreover, the external memory unit may be a recording medium such as an SD card or a CF card which is connected via a card reader.

In the USB memory 300, a content file storage area 310 is reserved and a content file is stored therein. Here, the content file in the present embodiment is a content that can be displayed on the display unit 120. For example, the content file refers to an image file (still image data) such as JPG, GIF, or PNG or a video file (moving image data) such as WMV, MPG, or AVI. Moreover, a text file such as PDF or HTML, a document file, and other files may be made usable.

### [1.2.2 Content Distribution Apparatus]

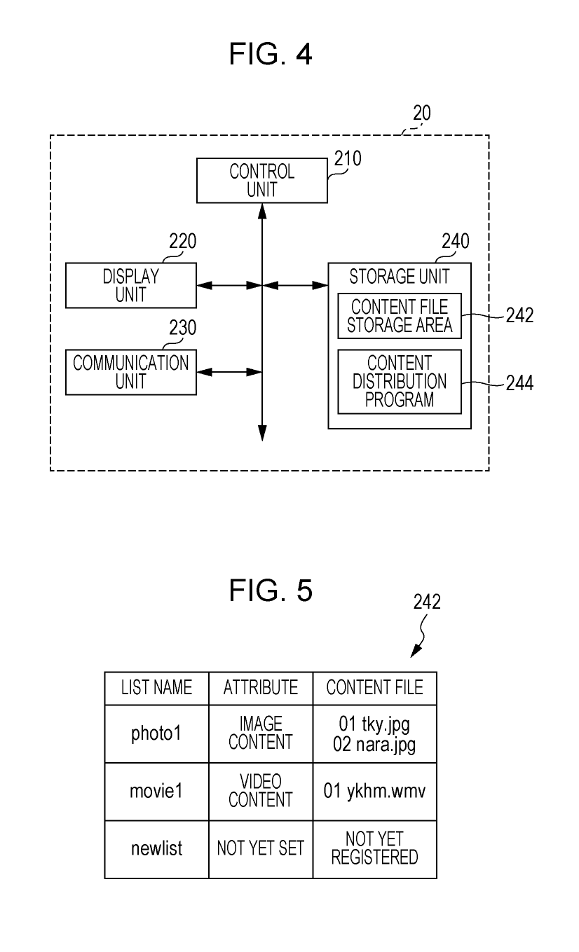

Next, the functional configuration of the content distribution apparatus 20 will be described with reference to FIG. 4. The content distribution apparatus 20 includes a control unit 210, a display unit 220, a communication unit 230, and a storage unit 240.

The control unit 210 is a functional unit for controlling the whole of the content distribution apparatus 20. The control unit 210 implements various functions by reading and executing various programs which are stored in the storage unit 240 and is configured with a central processing unit (CPU), for example.

The display unit 220 is a functional unit for displaying various operating screen contents by a content distribution function. For instance, the display unit 220 is configured with a liquid crystal display or an organic EL display. It goes without saying that the display unit 220 may be a projecting apparatus such as a projector or the contents may be displayed on an external display apparatus by using HDMI®.

The communication unit 230 is a functional unit with which the content distribution apparatus 20 communicates with the content display apparatus 10. For example, the communication unit 230 is implemented by an NIC that is used in a wired/wireless LAN or a communication module that is connectable to the 3G/LTE line. Moreover, near field communication such as Bluetooth® or ZigBee may be used.

The storage unit 240 is a functional unit that stores various programs and various kinds of data which are used by the content distribution apparatus 20 to operate. The storage unit 240 is configured with a semiconductor memory or a hard disk drive (HDD), for example.

Moreover, in the storage unit 240, a content file storage area 242 is reserved and a content distribution program 244 is stored therein.

The content file storage area 242 is an area in which one or more than one content file is stored for each list. A content file selected by the user from among the stored content files is sent or distributed to the content display apparatus 10.

As a result of the content distribution program 244 being read into the control unit 210 and executed thereby, the content distribution function is implemented. The content distribution program 244 can be executed, not only by the content distribution apparatus 20, but also by any information processing apparatus such as a common computer or a tablet terminal.

### [1.2.3 Content File]

Next, the content file that is stored in the content file storage area 242 for each list will be described with reference to FIG. 5.

In the content file storage area 242, the name (list name) of a list of content files, the attribute of the list, and one or more than one content file included in the list are stored in a state in which the name, the attribute, and the one or more than one content file are correlated with one another. The attribute of the list indicates that the one or more than one content file included in the list is an “image content” or a “video content”.

For example, in the content file storage area 242, a list name “photo1”, the attribute “image content” of the list, and a plurality of content files “01 tky.jpg” and “02 nara.jpg” are stored in a state in which the list name, the attribute, and the content files are correlated with one another. Moreover, in the content file storage area 242, a list name “movie1”, the attribute “video content” of the list, and a content file “01 ykhm.wmv” are stored in a state in which the list name, the attribute, and the content file are correlated with one another.

The plurality of content files “01 tky.jpg” and “02 nara.jpg” of the list name “photo1” or the content file “01 ykhm.wmv” of the list name “movie1” is distributed when the content distribution apparatus 20 displays contents (content files) of the same attribute on the content display apparatus 10 (see content distribution processing, which will be described later).

Moreover, in the content file storage area 242, a list name “newlist” is stored. The list name “newlist” indicates that the name of a list is not yet determined. Furthermore, in the content file storage area 242, the attribute of the list and a content file are not stored in a state in which the attribute and a content file are correlated with the list name “newlist”, which indicates that the attribute of the list is not yet set and a content file is not yet registered.

The attribute of the list name “newlist” is set based on a first content file (a new content file). If the attribute of the first content file (the new content file) is “image content”, the attribute of the list name “newlist” is also set to “image content”. Meanwhile, if the attribute of the first content file is “video content”, the attribute of the list name “newlist” is also set to “video content”. Incidentally, the name (“photo1”, “movie1”, “newlist”) of a list can be set to a desired name with user's desired timing at the time of creation of the list or after the creation of the list.

Here, in the present embodiment, a group including one or more than one content file is used as a list, but an embodiment is not limited thereto. For example, a folder may be adopted instead as long as the folder is a group including one or more than one content file.

### [1.3 Flow of Processing]

Next, the flow of processing in the present embodiment will be described with reference to the drawing.

### [1.3.1 Content Display Processing]

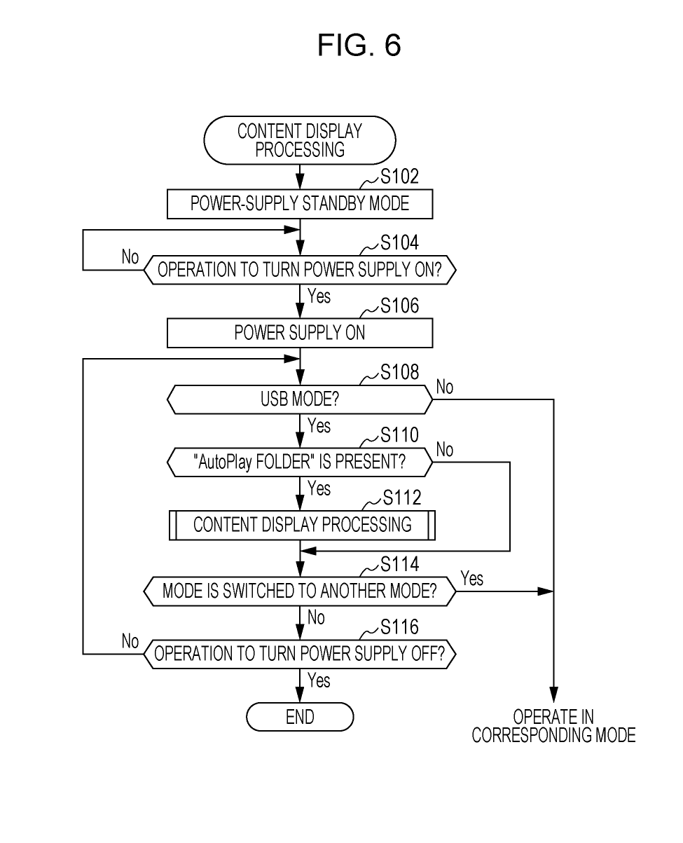

Content display processing which is executed in the content display apparatus 10 when the content display apparatus 10 displays a content will be described with reference to an operation flow of FIG. 6.

First, when a power supply is in a standby mode (a power-supply standby state) (Step S102), the content display apparatus 10 waits until an operation to turn the power supply ON is detected (No in Step S104). On the other hand, when the power supply is in a standby mode (a power-supply standby state) (Step S102), if an operation to turn the power supply ON is detected (Yes in Step S104), the state of the power supply transitions to “ON” (Step S106).

Here, as the state of the power supply of the content display apparatus 10, there are three states: a “power-supply standby state (a standby mode)”, a “signal standby state”, and an “ON (power supply ON) state”. First, the “power-supply standby state” is a state before the power supply is turned ON. The “signal standby state” is a state in which, although the power supply is ON, no signal is input from the outside when display is performed based on an external signal, such as an HDMI mode or a DVI mode, or the USB memory 300 (the external memory unit) is not connected in a USB mode. The “ON state” is a state in which the power supply is ON and a signal is input or content data is read from the USB memory 300 (the external memory unit).

Moreover, when the power supply state is ON, the content display apparatus 10 has a plurality of display modes. The mode can be switched therebetween in response to an external input. For instance, the mode can be switched in response to an input such as HDMI, DVI, D-SUB, or composite. Furthermore, the “USB mode” in which content data is read from the USB memory 300 (the external memory unit) can be selected.

If the “USB mode” is selected, the content display apparatus 10 checks whether or not an “AutoPlay folder” is present in the USB memory 300 (the external memory unit). If an “AutoPlay folder” is present, the content display apparatus 10 consecutively displays the content files included in the “AutoPlay folder”.

Specifically, in the flow, first, in any mode other than the USB mode, the content display apparatus 10 performs an operation corresponding to the selected mode (No in Step S108). In the present embodiment, explanations of the processing which would be executed in the other operation mode will be omitted.

Here, if the USB mode is selected (Yes in Step S108), the content display apparatus 10 determines whether or not an AutoPlay folder is present (Step S110).

That is, if the USB memory 300 is connected to the USB connecting unit 160 and an AutoPlay folder is present in the USB memory 300 (Yes in Step S110), content display processing is executed (Step S112).

The content display processing is processing by which contents based on the content files which are stored in the “AutoPlay folder” are sequentially displayed by a media player which is stored in the content display apparatus 10. For example, if the stored file numbers are serial numbers (01, 02, . . . ), the contents can be displayed or reproduced in the order of file numbers.

The media player has the function of displaying image contents or document contents and reproducing video contents based on the stored contents.

Moreover, in so doing, the media player may switch contents to be displayed at predetermined time intervals or display the contents at time intervals set by the user. Furthermore, an attribute may be given to each file and the media player may be made to display the contents sequentially.

Here, if the mode is not switched to another mode (No in Step S114) and an operation to turn the power supply OFF is not performed (No in Step S116), processing in and after Step S108 is executed and the contents are repeatedly displayed. If an operation to turn the power supply OFF is performed, the mode transitions to the power-supply standby state in the present embodiment.

On the other hand, if the mode is switched to another mode (Yes in Step S114), the content display apparatus 10 operates in a mode corresponding to that mode. Moreover, if the mode is not switched to another mode (No in Step S114) and an operation to turn the power supply OFF is performed (Yes in Step S116), the present processing is ended and the power supply is turned OFF.

### [1.3.2 Content Distribution Processing]

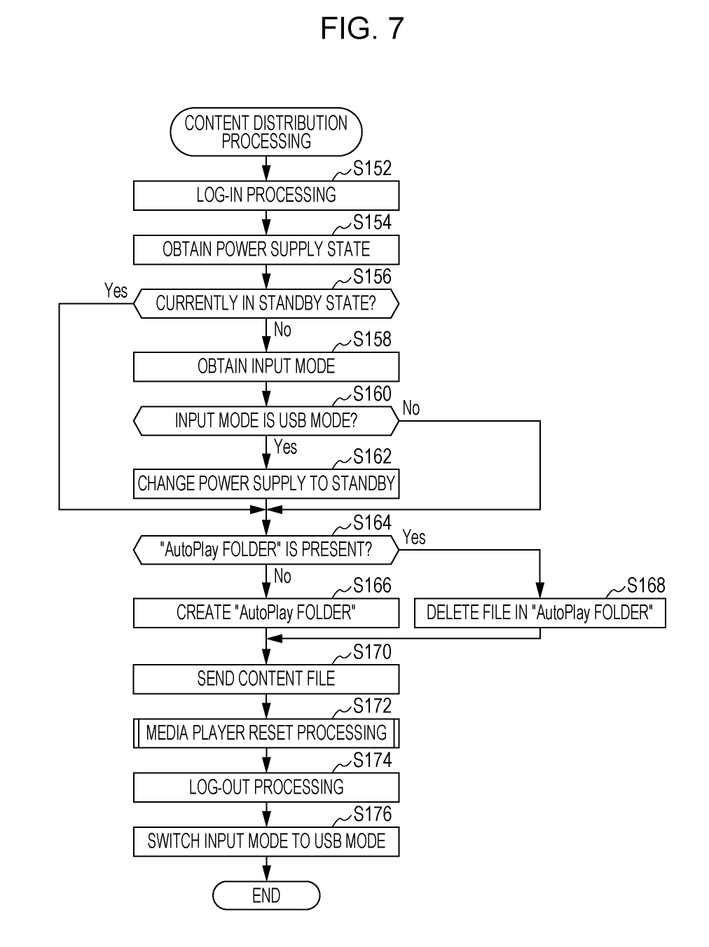

Content distribution processing which is executed by the content distribution apparatus 20 will be described with reference to FIG. 7.

First, the content distribution apparatus 20 logs in to the content display apparatus 10 (Step S152). For example, the content distribution apparatus 20 connects thereto by using Telnet for sending a command and connects thereto by using FTP for sending a content file. When obtaining the state of the content display apparatus 10, the content distribution apparatus 20 obtains the state by sending a command via Telnet, but it goes without saying that the content distribution apparatus 20 may use other protocols. For instance, the content distribution apparatus 20 may use SSH instead of Telnet and use SFTP/SCP instead of FTP.

Then, the content distribution apparatus 20 obtains the power supply state of the content display apparatus 10 (Step S154). This processing is executed so as not to execute processing such as storage or update of a file when the content display apparatus 10 is accessing the USB memory 300.

If the obtained power supply state is not the “power-supply standby state” (No in Step S156) and the current input mode is the USB mode (Step S158, Yes in Step S160), the content distribution apparatus 20 changes the power supply to the power-supply standby state (the standby mode) (Step S162). This can produce the effect of not allowing a screen which is being changed to be viewed by the user and the effect of making it possible to perform writing of a file safely.

In the present embodiment, the above effects are produced by changing the power supply to the “power-supply standby state”, but other methods are also possible. For example, the content distribution apparatus 20 may execute processing such as disconnecting a USB driver to hide the screen.

On the other hand, if the current power supply state is the “power-supply standby state” (Yes in Step S156), processing such as putting the power supply into standby (the power-supply standby state) is not executed. Moreover, if the obtained power supply state is not the “power-supply standby state” (No in Step S156) and the current input mode is a mode other than the USB mode (Step S158, No in Step S160), processing such as putting the power supply into standby (the power-supply standby state) is not executed.

Processing such as putting the power supply into standby (the power-supply standby state) is not executed in order to avoid the power supply from being put into standby since the system is not accessing the USB memory 300 and to keep displaying the contents if the contents are being displayed in another mode (for example, the contents input from the outside are being displayed in the HDMI mode).

Also in such a case, the power supply may be put into the power-supply standby state. For instance, the power supply may be put into the power-supply standby state, giving higher priority to safety, such as avoiding a breakdown of the file system.

Then, if an “AutoPlay folder” is not present in the USB memory 300 (No in Step S164), the content distribution apparatus 20 creates an “AutoPlay folder” (Step S166). On the other hand, if an “AutoPlay folder” is already present in the USB memory 300 (Yes in Step S164), the content distribution apparatus 20 deletes the file in the “AutoPlay folder” (Step S168).

In the present embodiment, the description deals with a case where the content distribution apparatus 20 deletes the file in the “AutoPlay folder”, but the content distribution apparatus 20 may keep the current content file as it is and provide an additional mode, which will be described later. If the additional mode is selected, Step S168 is not executed.

Alternatively, the content distribution apparatus 20 may execute processing to create a new folder (and delete the current folder) without exception.

Then, the content file is sent (Step S170). After the content file is sent, media player reset processing is executed (Step S172).

Here, the media player reset processing is executed by ON/OFF of the power supply of the content display apparatus 10, for example. Specifically, if an operation (a reset operation) by which the power supply of the content display apparatus 10 is turned OFF and then turned ON again is performed, the media player is reset and executes processing to display the content data in the “AutoPlay folder” again.

Incidentally, the content distribution apparatus 20 may execute log-in processing again because the log-in state performed in Step S152 is cancelled. For instance, the content distribution apparatus 20 executes log-in processing at predetermined time intervals and, if the state enters a state in which log-in is completed, the content distribution apparatus 20 can determine that the media player reset processing is completed.

Then, after log-out processing (Step S174), as a result of the content distribution apparatus 20 performing control to switch the input mode to the USB mode (Step S176), the content data sent in Step S170 is displayed or reproduced by the media player.

### [1.3.3 Content File Addition Processing]

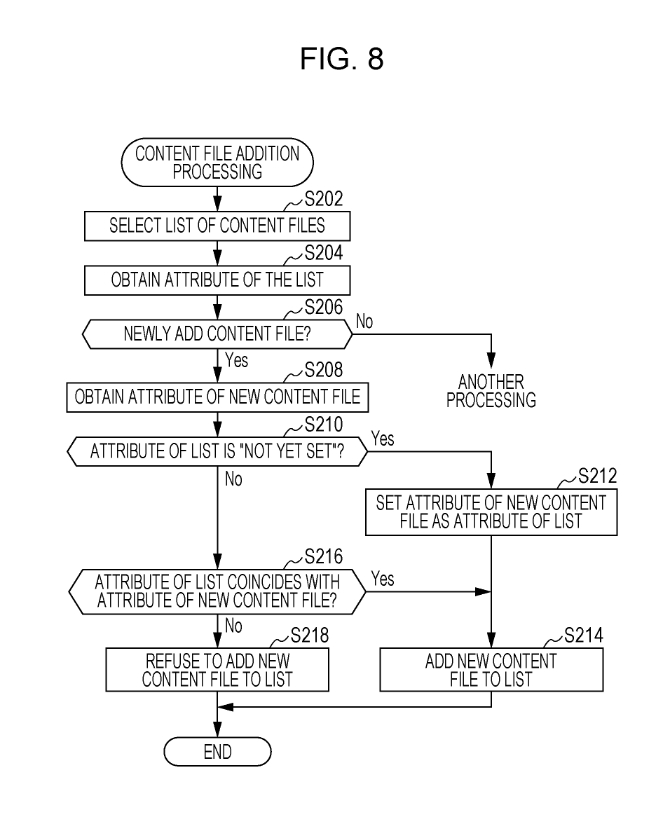

Content file addition processing which is executed by the content distribution apparatus 20 will be described with reference to FIG. 8.

First, the content distribution apparatus 20 selects a list of content files which are stored in the content file storage area 242 of the storage unit 240 (Step S202). In so doing, the content distribution apparatus 20 obtains the attribute of the list (Step S204).

If the content distribution apparatus 20 does not add a content file to the list (No in Step S206), the content distribution apparatus 20 executes another processing. Examples of another processing include change of the file name of the content file.

On the other hand, if the content distribution apparatus 20 newly adds a content file to the list (Yes in Step S206), the content distribution apparatus 20 obtains the attribute “image content” or “video content” of the new content file (Step S208).

Here, if the attribute of the list is “not yet set” (Yes in Step S210), that is, if the list name “newlist” is selected as a list from the content file storage area 242 of the storage unit 240 in Step S202, the attribute of the list which is stored in the content file storage area 242 is “not yet set”. In this case, the content distribution apparatus 20 sets (determines) the attribute “image content” or “video content” of the new content file as the attribute of the list (Step S212).

The content distribution apparatus 20 adds the new content file to that list (Step S214). In this case, in the content file storage area 242 of the storage unit 240, the attribute “image content” or “video content” of the list and the new content file are stored as a list in a state in which the attribute and the new content file are correlated with the list name “newlist”.

On the other hand, if the attribute of the list is not “not yet set” (No in Step S210), that is, if the list name “photo1” or “movie1” is selected from the content file storage area 242 of the storage unit 240 as a list in Step S202, the attribute of the list which is stored in the content file storage area 242 is “image content” or “video content”. In this case, the content distribution apparatus 20 checks whether or not the attribute “image content” or “video content” of the list coincides with the attribute of the new content file (Step S216).

Here, if the attribute “image content” or “video content” of the list coincides with the attribute of the new content file (Yes in Step S216), the content distribution apparatus 20 adds the new content file to that list (Step S214). In this case, in the content file storage area 242 of the storage unit 240, the new content file is stored as a list in a state in which the new content file is correlated with the list name “photo1” or “movie1” and the attribute “image content” or “video content” of the list.

On the other hand, if the attribute “image content” or “video content” of the list does not coincide with the attribute of the new content file (No in Step S216), the content distribution apparatus 20 refuses to add the new content file to the list and displays a message to that effect on the display unit 220 (Step S218).

### [1.4 Operation Example]

Next, specific operation examples (screen examples) will be described with reference to the drawings.

### [1.4.1 Operation Example 1]

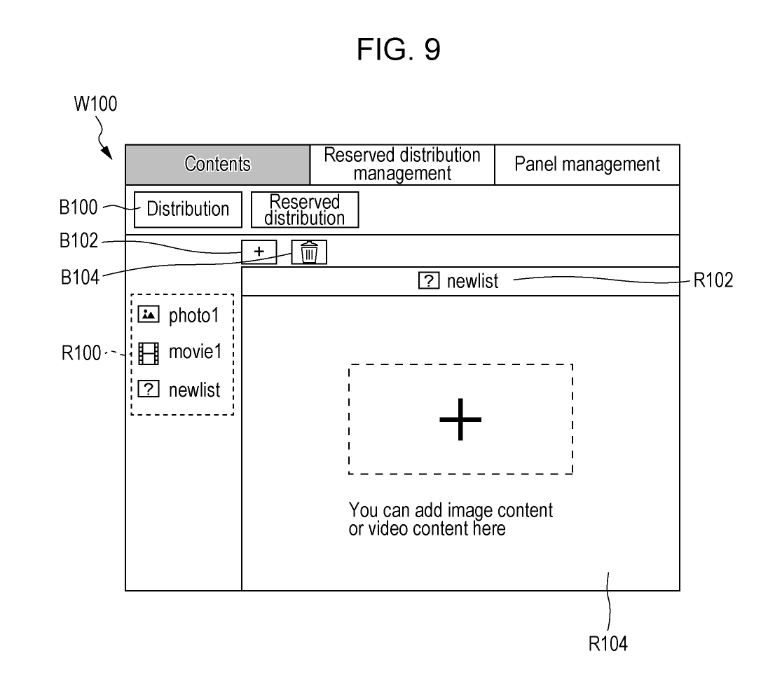

First, an operation which is performed when the content distribution apparatus 20 executes the content file addition processing will be described with reference to FIGS. 9 to 12.

FIG. 9 is an example of a display screen W100 which is displayed on the display unit 220 in the content distribution apparatus 20. The display screen W100 is displayed on the display unit 220 as a result of Step S202 of the content file addition processing being executed. That is, when the list name “newlist” is selected as a list, the display screen W100 is displayed on the display unit 220.

The display screen W100 includes an operating button region, a region R100, a region R102, and a region R104.

In the operating button region, a plurality of operating buttons are displayed. For example, in the operating button region, a distribution button B100 for actually distributing a content file to the content display apparatus 10, an addition button B102 for adding a content file to a list, and a deletion button B104 for deleting a content file from a list are displayed.

In the region R100, a listing of lists of content files is displayed. Specifically, in the region R100, the attribute of a list and the list name are displayed side by side. Since the attributes of lists (for example, a list of video contents and a list of still image contents) are distinguishably displayed, the user can intuitively distinguish a content in one list from a content in another list. For example, the attribute “image content” of the list and the list name “photo1” are displayed side by side. Moreover, the attribute “video content” of the list and the list name “movie1” are displayed side by side. Furthermore, the attribute “not yet set” of the list and the list name “newlist” are displayed side by side. The attribute “not yet set” of the list is an indication to the effect that the attribute of the list is not yet determined.

In the region R102, the list name “newlist” of the list selected from the listing of lists which is displayed in the region R100 is displayed. The selected list (the attribute “not yet set” of the list, the list name “newlist”) only has to be displayed in such a way that the user can identify the selected list. For instance, the selected list may be distinguishably displayed (for example, highlighted) in the listing of lists which is displayed in the region R100.

In the region R104, a message to the effect that an “image content” or a “video content” can be added to the selected list is displayed.

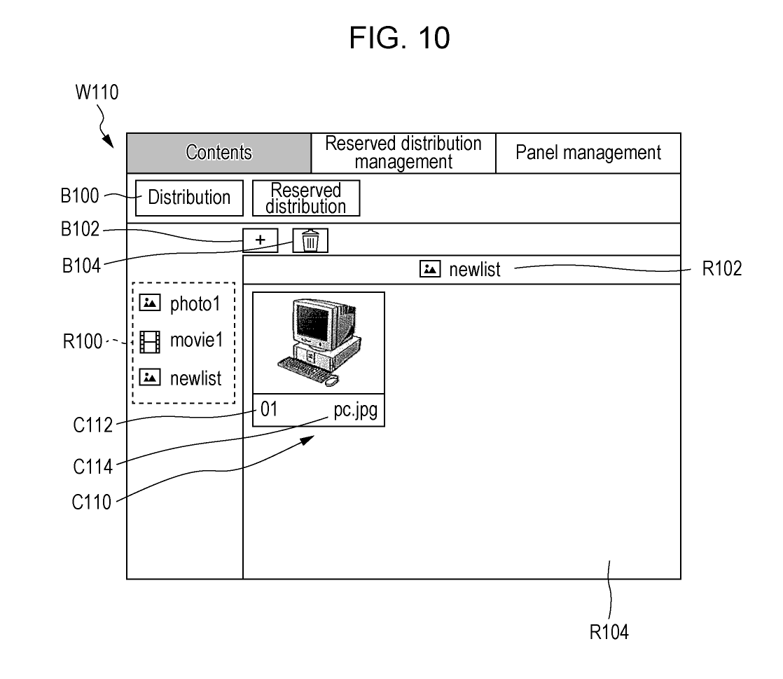

FIG. 10 is an example of a display screen W110 which is displayed on the display unit 220 in the content distribution apparatus 20. The display screen W110 is displayed on the display unit 220 as a result of Steps S202, S204, S206—Yes, S208, S210—Yes, S212, and S214 of the content file addition processing being executed. That is, the display screen W110 is displayed on the display unit 220 when a new content file “01 pc.jpg” whose attribute is “image content” is added to the list (the list name “newlist”).

In the region R104, a content file (a new content file) to be added to the list (the list name “newlist”) is displayed. For example, the new content file is displayed when the addition button B102 is operated. Alternatively, the new content file is displayed as a result of drag and drop from another display screen being performed.

The new content file displayed in the region R104 is displayed in the shape of a tile. As the new content file, for example, a content C110, an order C112, and a file name C114 are displayed in the region R104. The content C110 indicates the details of the content file (for instance, an image of a personal computer). The file name C114 indicates the file name “pc.jpg” of the content C110. The order C112 indicates an order “01” in the selected list (the list name “newlist”). The order C112 allows the user to understand that the content C110 is a first content to be displayed or reproduced. The content file may be displayed in list form, for example, not in the shape of a tile.

If the new content file “01 pc.jpg” is displayed in the region R104, in the content file storage area 242 of the storage unit 240, the attribute “image content” of the list and the new content file “01 pc.jpg” are stored as a list in a state in which the attribute and the new content file are correlated with the list name “newlist”. In this case, the attribute of the list which is displayed in the region R100 beside the list name “newlist” is changed from the indication “not yet set” to the effect that the attribute of the list is not yet determined to “image content”. Moreover, the attribute of the list which is displayed in the region R102 is changed from the indication “not yet set” to the effect that the attribute of the list is not yet determined to “image content”.

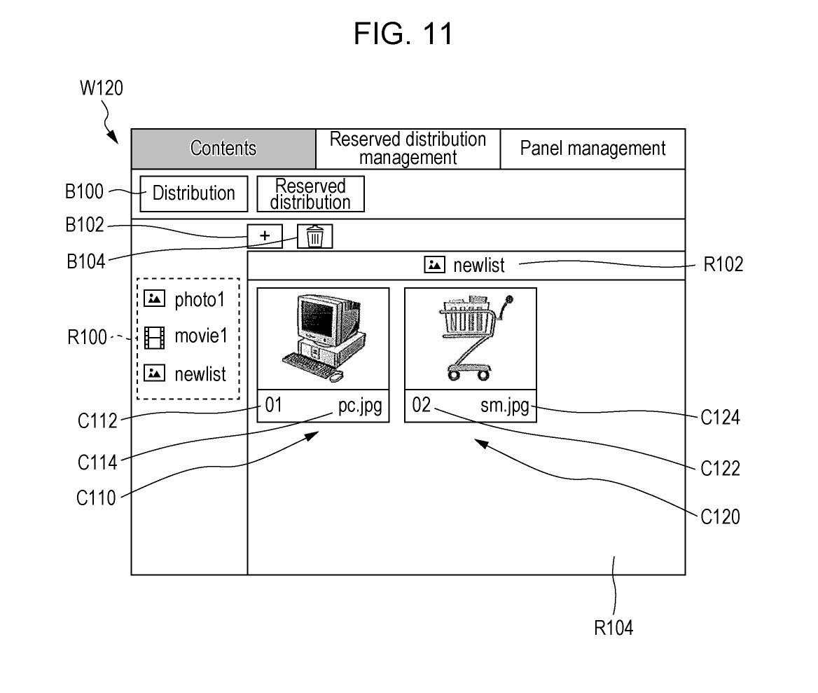

FIG. 11 is an example of a display screen W120 which is displayed on the display unit 220 in the content distribution apparatus 20. The display screen W120 is displayed on the display unit 220 as a result of Steps S202, S204, S206—Yes, S208, S210—No, S216—Yes, and S214 of the content file addition processing being executed. That is, the display screen W120 is displayed on the display unit 220 when a new content file “02 sm.jpg” whose attribute is “image content” is added to the list (the list name “newlist”).

In the region R104, the content file “01 pc.jpg” included in the list (the list name “newlist”) and a content file (a new content file) to be added to the list are displayed. For example, the new content file is displayed when the addition button B102 is operated. Alternatively, the new content file is displayed as a result of drag and drop from another display screen being performed.

The new content file displayed in the region R104 is displayed in the shape of a tile. As the new content file, for example, in the region R104, a content C120, an order C122, and a file name C124 are displayed. The content C120 indicates the details of the content file (for example, an image of a shopping cart). The file name C124 indicates the file name “sm.jpg” of the content C120. The order C122 indicates an order “02” in the selected list (the list name “newlist”). The order C122 allows the user to understand that the content C120 is a second content to be displayed or reproduced.

If the new content file “02 sm.jpg” is displayed in the region R104, in the content file storage area 242 of the storage unit 240, the attribute “image content” of the list and the new content file “02 sm.jpg” are stored as a list in a state in which the attribute and the new content file are correlated with the list name “newlist”.

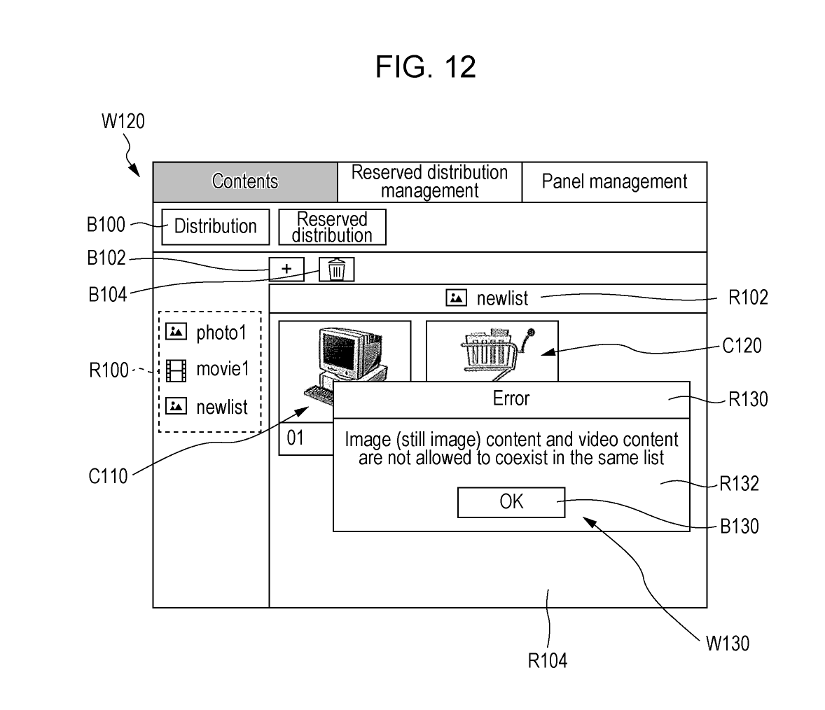

FIG. 12 is an example of a display screen W130 which is displayed on the display unit 220 in the content distribution apparatus 20. The display screen W130 is displayed on the display unit 220 as a result of Steps S202, S204, S206—Yes, S208, S210—No, S216—No, and S218 of the content file addition processing being executed. That is, when an attempt to add a new content file whose attribute is “video content” to the list (the list name “newlist”) is made, the display screen W130 is displayed on the display unit 220 if the content distribution apparatus 20 refuses to add the new content file to the list (the list name “newlist”).

The display screen W130 is displayed on the display screen W120. The display screen W130 includes a region R130 and a region R132.

In the region R130, a message to the effect that adding the new content file whose attribute is “video content” to the list (the list name “newlist”) is an error is displayed.

In the region R132, a message to the effect that an “image content” and a “video content” are not allowed to coexist in the list (the list name “newlist”) is displayed. In the region R132, an operating button B130 for closing the display screen W130 is displayed.

In a common digital signage system, a content which is displayed by the content display apparatus is changed depending on the installation site of the content display apparatus or time. Thus, in the digital signage system, if the attribute of a list is set in advance, a content display apparatus for displaying an image content and a content display apparatus for displaying a video content have to be installed in the same installation site, for example. For this reason, in the digital signage system (the content distribution system 1) according to the present embodiment, the attribute “image content” of the newly added content file “01 pc.jpg” is determined as the attribute of the list (the list name “newlist”). In this case, when the content file “02 sm.jpg” is added to the list (the list name “newlist”), since the attribute of the content file “02 sm.jpg” coincides with the attribute of the list (the list name “newlist”), the content file “02 sm.jpg” is added to the list (the list name “newlist”). Therefore, it is possible to distribute contents of the same attribute to the content display apparatus 10 without setting the attribute of the list (the list name “newlist”) in advance.

### [1.4.2 Operation Example 2]

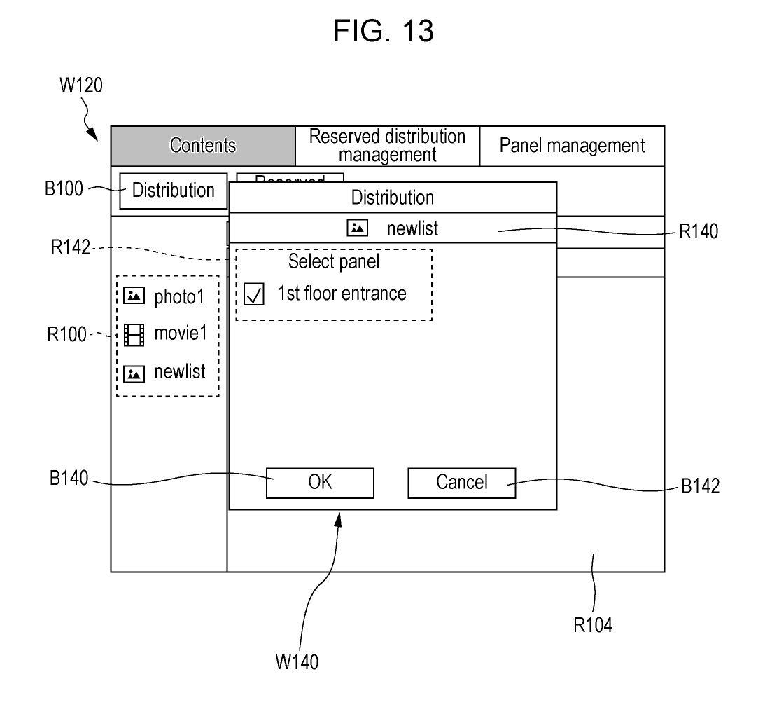

First, an operation which is performed when the content distribution apparatus 20 executes the content distribution processing will be described with reference to FIG. 13.

FIG. 13 is an example of a display screen W140 which is displayed on the display unit 220 in the content distribution apparatus 20. The display screen W140 is displayed on the display unit 220 as a result of Step S170 of the content distribution processing being executed. That is, the display screen W140 is displayed when the distribution button B100 is operated.

The display screen W140 is displayed on the display screen W120. The display screen W140 includes a region R140 and a region R142.

In the region R140, a message to the effect that the list name “newlist” is selected as a list whose content file is to be distributed to the content display apparatus 10 is displayed.

In the region R142, a site where the content display apparatus 10 is installed is indicated. For instance, as a site where the content display apparatus 10 is installed, the entrance on the first floor of a store or a shopping mall is indicated. In the region R142, an operating button B140 for distributing the content file to the content display apparatus 10 and an operating button B142 for closing the display screen W140 without distributing the content file to the content display apparatus 10 are displayed.

Here, when the user selects a site where the content display apparatus 10 is installed and operates the operating button B140, the content files “01 pc.jpg” and “02 sm.jpg” included in the list name “newlist” are sent to the selected content display apparatus 10. In this case, in the external memory unit (the USB memory 300) which is connected to the content display apparatus 10, the content files “01 pc.jpg” and “02 sm.jpg” are stored. Therefore, the user does not have to copy every content file by inserting and extracting the USB memory 300, which makes it possible for the user to manage the content file appropriately.

### [1.4.3 Operation Example 3]

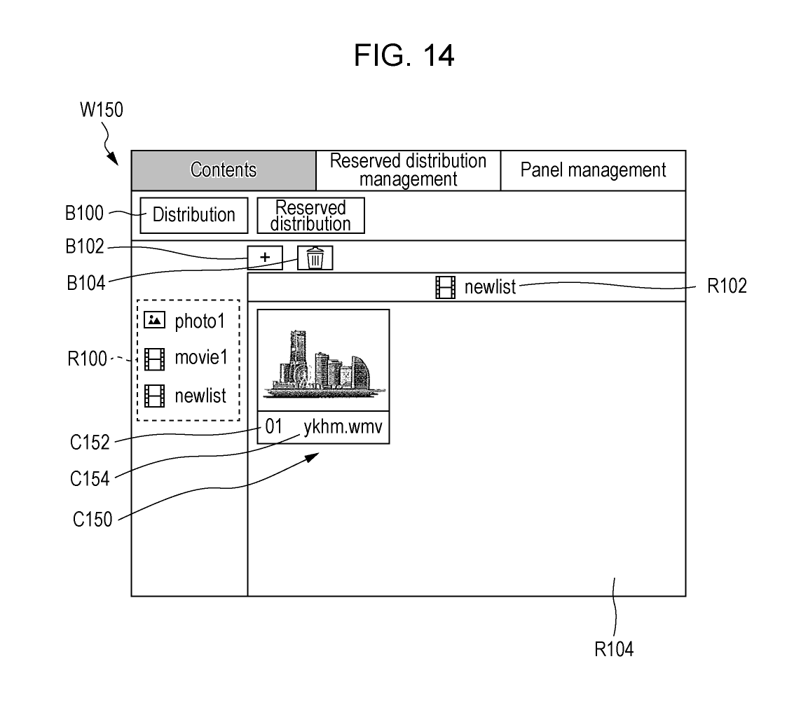

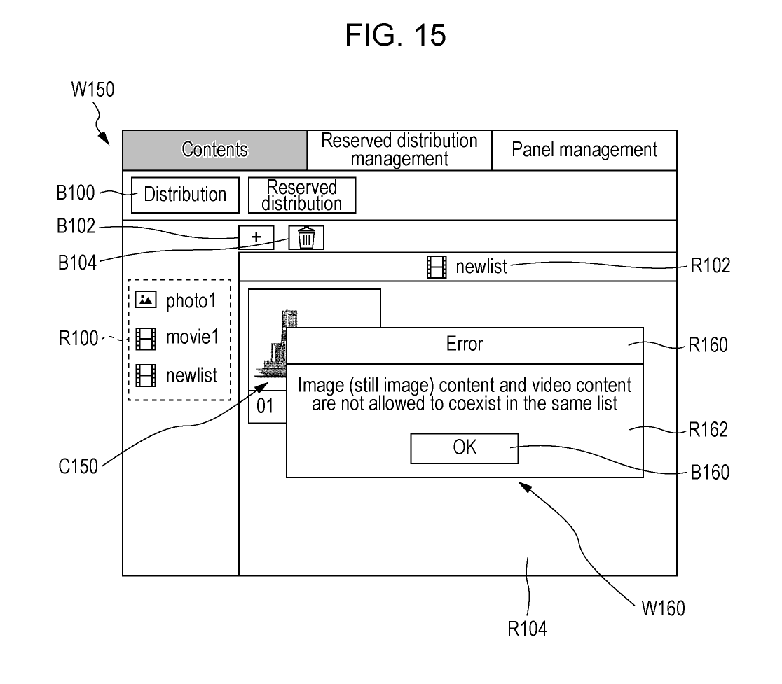

First, another operation which is performed when the content distribution apparatus 20 executes the content file addition processing will be described with reference to FIGS. 14 and 15.

FIG. 14 is an example of a display screen W150 which is displayed on the display unit 220 in the content distribution apparatus 20. The display screen W150 is displayed on the display unit 220 as a result of Steps S202, S204, S206—Yes, S208, S210—Yes, S212, and S214 of the content file addition processing being executed. That is, the display screen W150 is displayed on the display unit 220 when a new content file “01 ykhm.wmv” whose attribute is “video content” is added to the list (the list name “newlist”).

In the region R104, a content file (a new content file) to be added to the list (the list name “newlist”) is displayed. For example, the new content file is displayed when the addition button B102 is operated. Alternatively, the new content file is displayed as a result of drag and drop from another display screen being performed.

The new content file displayed on the region R104 is displayed in the shape of a tile. As the new content file, for example, in the region R104, a content C150, an order C152, and a file name C154 are displayed. The content C150 indicates the details of the content file (for example, video of a townscape). The file name C154 indicates the file name “ykhm.wmv” of the content C150. The order C152 indicates an order “01” in the selected list (the list name “newlist”). The order C152 allows the user to understand that the content C150 is a first content to be displayed or reproduced. The content file may be displayed in list form, for example, not in the shape of a tile.

If the new content file “01 ykhm.wmv” is displayed in the region R104, in the content file storage area 242 of the storage unit 240, the attribute “video content” of the list and the new content file “01 ykhm.wmv” are stored as a list in a state in which the attribute and the new content file are correlated with the list name “newlist”. In this case, the attribute of the list which is displayed beside the list name “newlist” in the region R100 is changed from the indication “not yet set” to the effect that the attribute of the list is not yet determined to “video content”. Moreover, the attribute of the list which is displayed in the region R102 is changed from the indication “not yet set” to the effect that the attribute of the list is not yet determined to “video content”.

FIG. 15 is an example of a display screen W160 which is displayed on the display unit 220 in the content distribution apparatus 20. The display screen W160 is displayed on the display unit 220 as a result of Steps S202, S204, S206—Yes, S208, S210—No, S216—No, and S218 of the content file addition processing being executed. That is, when an attempt to add a new content file whose attribute is “image content” to the list (the list name “newlist”) is made, the display screen W160 is displayed on the display unit 220 if the content distribution apparatus 20 refuses to add the new content file to the list (the list name “newlist”).

The display screen W160 is displayed on the display screen W150. The display screen W160 includes a region R160 and a region R162.

In the region R160, a message to the effect that adding a new content file whose attribute is “image content” to the list (the list name “newlist”) is an error is displayed.

In the region R162, a message to the effect that an “image content” and a “video content” are not allowed to coexist in the list (the list name “newlist”) is displayed. In the region R162, an operating button B160 for closing the display screen W160 is displayed.

In the digital signage system (the content distribution system 1) according to the present embodiment, the attribute “video content” of the newly added content file “01 ykhm.wmv” is determined as the attribute of the list (the list name “newlist”). In this case, when a next content file is added to the list (the list name “newlist”), since the attribute of the content file does not coincide with the attribute of the list (the list name “newlist”), the next content file is not added to the list (the list name “newlist”). Therefore, it is possible to distribute contents of the same attribute to the content display apparatus 10 without setting the attribute of the list (the list name “newlist”) in advance.

### 2. Second Embodiment

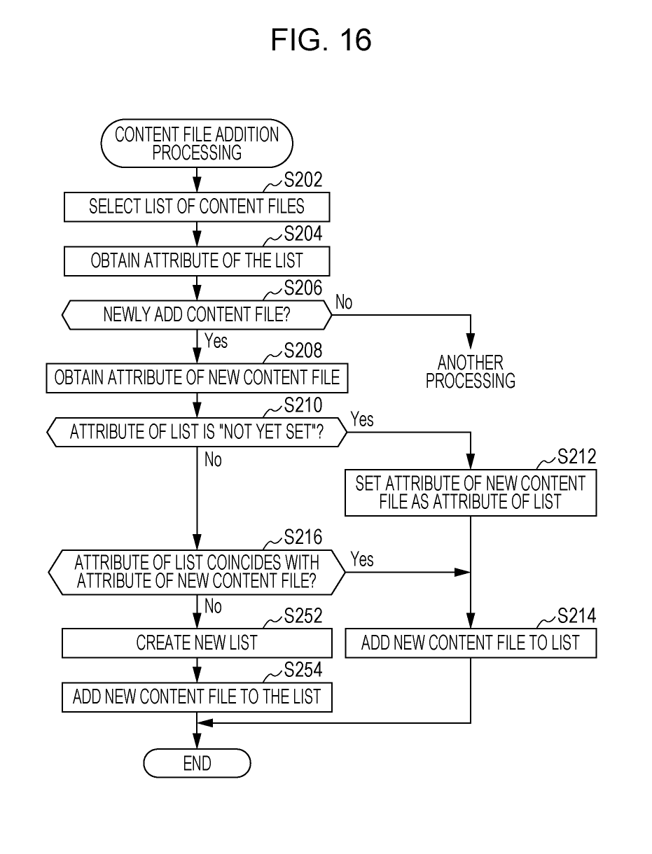

Next, a second embodiment will be described. The second embodiment is the same as the first embodiment in function and configuration, but the processing of the content distribution apparatus 20 described in FIG. 8 is replaced with processing described in FIG. 16. In the present embodiment, the description will center on this processing. It is to be noted that the same processing as the processing described in FIG. 8 of the first embodiment will be identified with the same reference character and detailed explanations thereof will be omitted.

### [2.1 Content File Addition Processing]

Content file addition processing which is executed by the content distribution apparatus 20 will be described with reference to FIG. 16.

First, Steps S202, S204, S206—Yes, S208, S210—No, and S216 are executed. Here, if the attribute “image content” or “video content” of the list does not coincide with the attribute of the new content file (No in Step S216), the content distribution apparatus 20 creates a new list (Step S252) and adds the new content file to that list (Step S254).

### [2.2 Operation Example]

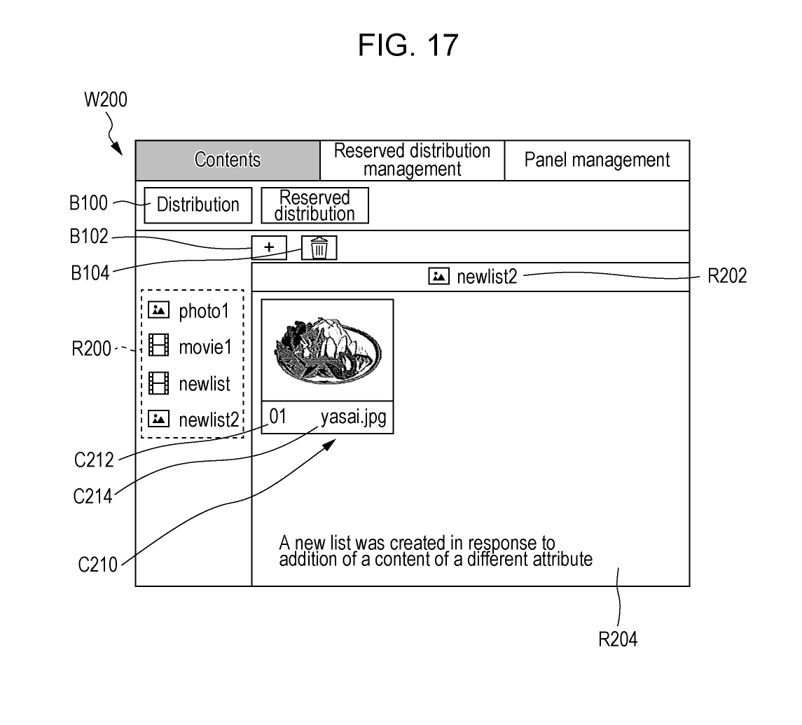

An operation which is performed when the content distribution apparatus 20 executes the content file addition processing will be described with reference to FIG. 17.

FIG. 17 is an example of a display screen W200 which is displayed on the display unit 220 in the content distribution apparatus 20. The display screen W200 is displayed on the display unit 220 as a result of Steps S202, S204, S206—Yes, S208, S210—No, S216—No, S252, and S254 of the content file addition processing being executed. That is, when an attempt to add a new content file whose attribute is “image content” to the list (the list name “newlist”) is made, a new list is created, and, when the new content file is added to that list, the display screen W200 is displayed on the display unit 220.

The display screen W200 includes an operating button region (a distribution button B100, an addition button B102, and a deletion button B104), a region R200, a region R202, and a region R204.

In the region R200, a listing of lists of content files is displayed. For example, the attribute “image content” of the list and the list name “photo1” are displayed side by side. Moreover, the attribute “video content” of the list and the list name “movie1” are displayed side by side. Furthermore, the attribute “video content” of the list and the list name “newlist” are displayed side by side. A list name “newlist2” is created when Step S252 is executed. In this case, in the content file storage area 242 of the storage unit 240, the list name “newlist2” and the attribute “not yet set” of the list are stored as a list in a state in which the list name and the attribute are correlated with each other, and, in the region R200, the attribute “not yet set” of the list and the list name “newlist2” are displayed side by side.

In the region R202, the list name “newlist2” of the list newly created in the listing of lists which is displayed in the region R200 is displayed. The list name “newlist2” is displayed in the region R202 when Step S252 is executed.

In the region R204, a content C210, an order C212, and a file name C214 are displayed. Moreover, in the region R204, a message to the effect that a new list has been created because a content having a different attribute was added is displayed. When the message to the effect that the new list has been created is displayed in the region R204, in the content file storage area 242 of the storage unit 240, the attribute “image content” of the list and a new content file “01 yasai.jpg” are stored as a list in a state in which the attribute and the new content file are correlated with the list name “newlist2”. In this case, the attribute of the list which is displayed beside the list name “newlist2” in the region R200 is changed from the indication “not yet set” to the effect that the attribute of the list is not yet determined to “image content”. Moreover, the attribute of the list which is displayed in the region R202 is changed from the indication “not yet set” to the effect that the attribute of the list is not yet determined to “image content”.

In the digital signage system (the content distribution system 1) according to the present embodiment, when a content file “yasai.jpg” is added to the list (the list name “newlist”), if the attribute of the content file “yasai.jpg” does not coincide with the attribute of the list (the list name “newlist”), a new list (a list name “newlist2”) is generated and the content file “01 yasai.jpg” is added to that list (the list name “newlist2”). Therefore, it is possible to distribute contents of the same attribute to the content display apparatus 10 without setting the attribute of the list (the list name “newlist2”) in advance.

### 3. Third Embodiment

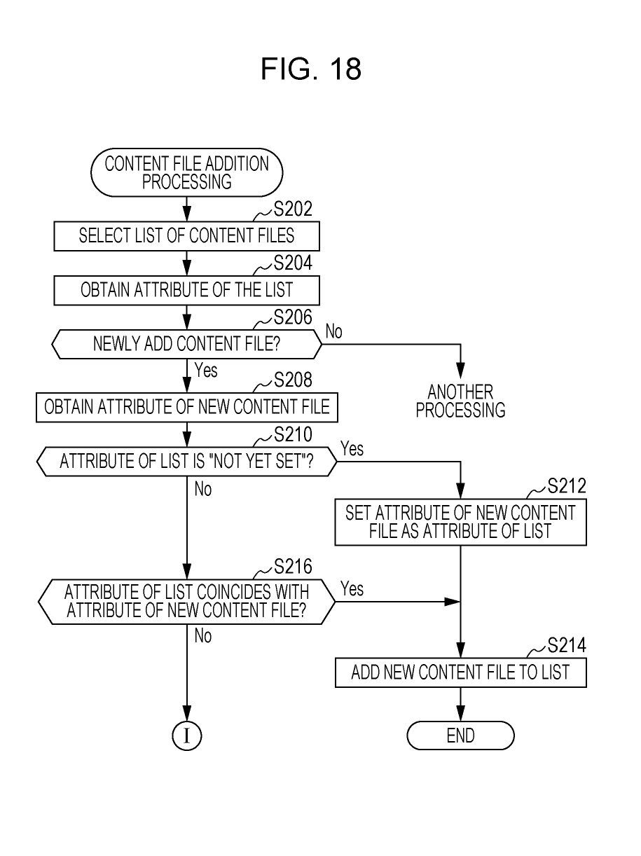

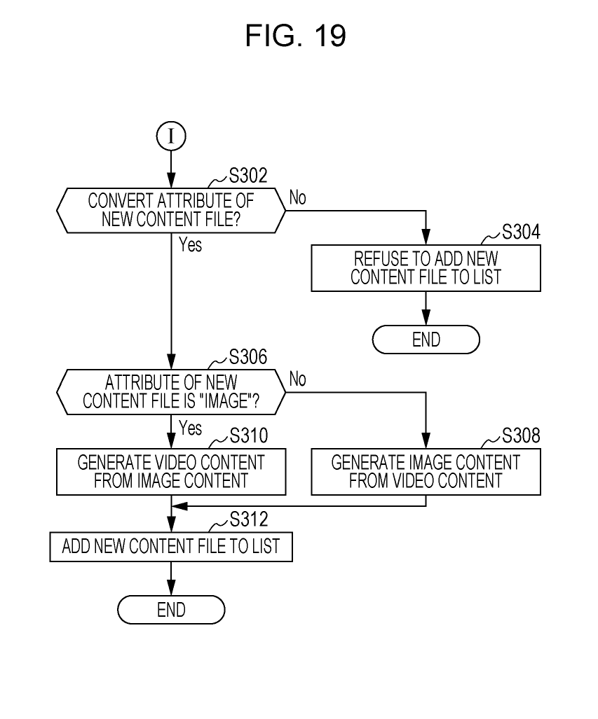

Next, a third embodiment will be described. The third embodiment is the same as the second embodiment in function and configuration, but the processing of the content distribution apparatus 20 described in FIG. 16 is replaced with processing described in FIGS. 18 and 19. In the present embodiment, the description will center on this processing. It is to be noted that the same processing as the processing described in FIG. 16 of the second embodiment will be identified with the same reference character and detailed explanations thereof will be omitted.

Content file addition processing which is executed by the content distribution apparatus 20 will be described with reference to FIGS. 18 to 20.

First, Steps S202, S204, S206—Yes, S208, S210—No, and S216 are executed. Here, if the attribute “image content” or “video content” of the list (the list name “newlist”) does not coincide with the attribute of the new content file (No in Step S216), the content distribution apparatus 20 inquires of the user whether he/she will convert the attribute “image content” or “video content” of the new content file (Step S302).

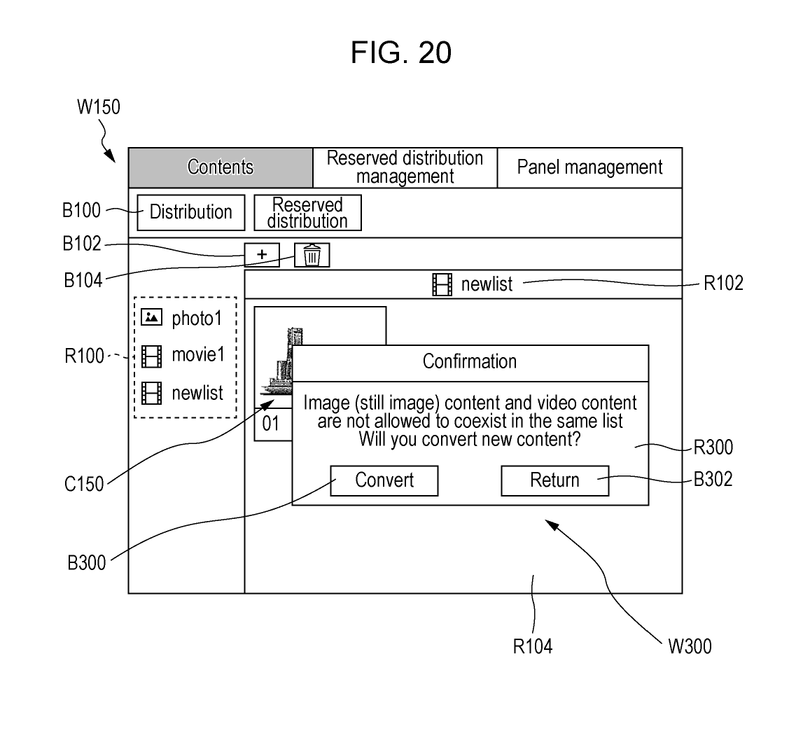

FIG. 20 is an example of a display screen W300 which is displayed on the display unit 220 in the content distribution apparatus 20.

The display screen W300 is displayed on the display screen W150. The display screen W300 includes a region R300.

In the region R300, a message inquiring of the user whether he/she will convert the attribute of the new content file because an “image content” and a “video content” are not allowed to coexist in the list (the list name “newlist”) is displayed. In the region R300, an operating button B300 for converting the attribute of the new content file and an operating button B302 for closing the display screen W300 without converting the attribute of the new content file are displayed.

Here, if the operating button B302 is operated, that is, if an instruction not to convert the attribute of the new content file is given (No in Step S302), the content distribution apparatus 20 refuses to add the new content file to the list (the list name “newlist”) and displays a message to that effect on the display unit 220 (Step S304).

On the other hand, if the operating button B300 is operated, that is, if an instruction to convert the attribute of the new content file is given (Yes in Step S302), the content distribution apparatus 20 checks the attribute of the new content file (Step S306).

Here, if the attribute of the new content file is “video content” (No in Step S306), the content distribution apparatus 20 generates an “image content” from the “video content” of the new content file and includes the “image content” in the list (the list name “newlist”) (Step S308). The content distribution apparatus 20 adds the new content file to that list (Step S312).

On the other hand, if the attribute of the new content file is “image content” (Yes in Step S306), the content distribution apparatus 20 includes the new content file to the list (the list name “newlist”) and generates a “video content” from the “image content” in such a way as to create a slide show (Step S310). The content distribution apparatus 20 adds the new content file to that list (Step S312).

In the digital signage system (the content distribution system 1) according to the present embodiment, when a content file is added to the list (the list name “newlist”), if the attribute of the content file does not coincide with the attribute of the list (the list name “newlist”), the attribute of the new content file is converted to the attribute of the list (the list name “newlist”) and the content file is added to the list (the list name “newlist”). Therefore, it is possible to distribute contents of the same attribute to the content display apparatus 10 without setting the attribute of the list (the list name “newlist”) in advance.

### 4. Fourth Embodiment

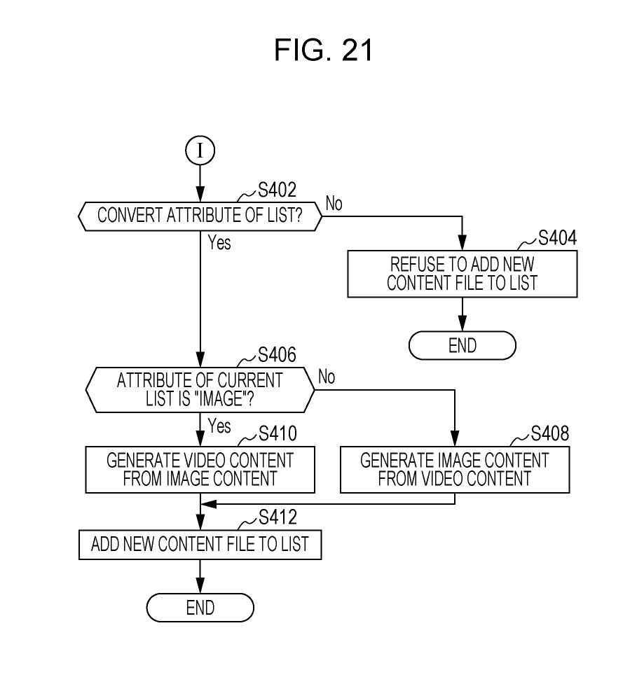

Next, a fourth embodiment will be described. The fourth embodiment is the same as the third embodiment in function and configuration, but the processing of the content distribution apparatus 20 described in FIG. 19 is replaced with processing described in FIG. 21. Specifically, in the third embodiment, the attribute of a new content file is converted to the attribute of the list (the list name “newlist”); in the fourth embodiment, the attribute of the list (the list name “newlist”) is converted to the attribute of a new content file. In the present embodiment, the description will center on this processing.

Content file addition processing which is executed by the content distribution apparatus 20 will be described with reference to FIGS. 18, 21, and 22.

First, Steps S202, S204, S206—Yes, S208, S210—No, and S216 are executed. Here, if the attribute “image content” or “video content” of the list (the list name “newlist”) does not coincide with the attribute of the new content file (No in Step S216), the content distribution apparatus 20 inquires of the user whether he/she will convert the attribute “image content” or “video content” of the list (the list name “newlist”) (Step S402).

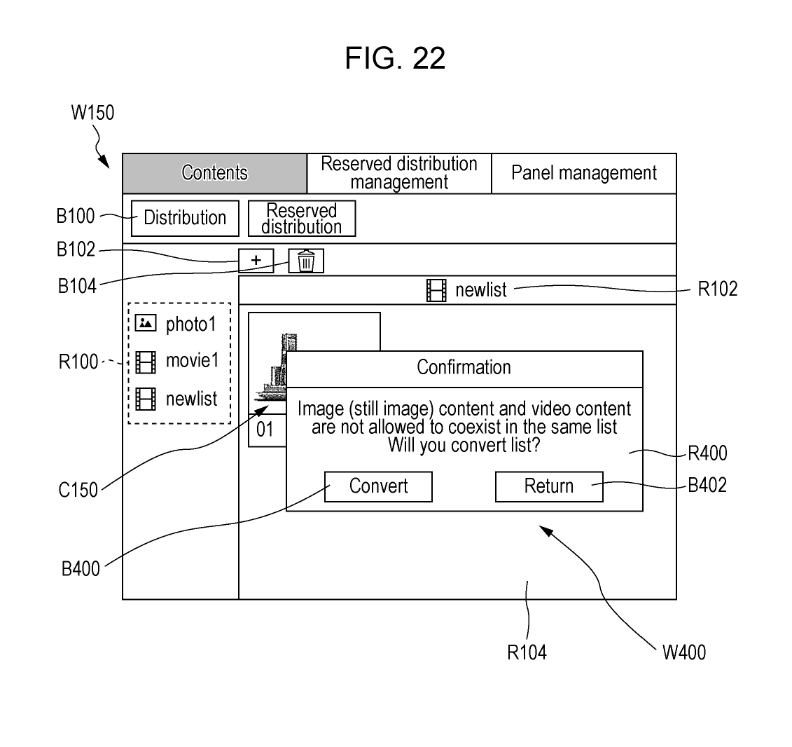

FIG. 22 is an example of a display screen W400 which is displayed on the display unit 220 in the content distribution apparatus 20.

The display screen W400 is displayed on the display screen W150. The display screen W400 includes a region R400.

In the region R400, a message inquiring of the user whether he/she will convert the attribute of the list (the list name “newlist”) because an “image content” and a “video content” are not allowed to coexist in the list (the list name “newlist”) is displayed. In the region R400, an operating button B400 for converting the attribute of the list (the list name “newlist”) and an operating button B402 for closing the display screen W400 without converting the attribute of the list (the list name “newlist”) are displayed.

Here, if the operating button B402 is operated, that is, if an instruction not to convert the attribute of the list (the list name “newlist”) is given (No in Step S402), the content distribution apparatus 20 refuses to add the new content file to the list (the list name “newlist”) and displays a message to that effect on the display unit 220 (Step S404).

On the other hand, if the operating button B400 is operated, that is, if an instruction to convert the attribute of the list (the list name “newlist”) is given (Yes in Step S402), the content distribution apparatus 20 checks the attribute of the list (the list name “newlist”) (Step S406).

Here, if the attribute of the list (the list name “newlist”) is “video content” (No in Step S406), the content distribution apparatus 20 generates an “image content” from the “video content” of the content file included in the list (the list name “newlist”) (Step S408). The content distribution apparatus 20 adds the new content file to that list (Step S412).

On the other hand, if the attribute of the list (the list name “newlist”) is “image content” (Yes in Step S406), the content distribution apparatus 20 generates a “video content” from the “image content” of the content file included in the list (the list name “newlist”) in such a way as to create a slide show (Step S410). The content distribution apparatus 20 adds the new content file to that list (Step S412).

In the digital signage system (the content distribution system 1) according to the present embodiment, when a content file is added to the list (the list name “newlist”), if the attribute of the content file does not coincide with the attribute of the list (the list name “newlist”), the attribute of the list (the list name “newlist”) is converted to the attribute of the content file and the content file is added to the list (the list name “newlist”). Therefore, it is possible to distribute contents of the same attribute to the content display apparatus 10 without setting the attribute of the list (the list name “newlist”) in advance.

### [5. Modified Examples]

The present disclosure is not limited to the embodiments described above and various changes and modifications are possible. That is, any embodiment that is obtained by combining the technical measures achieved by appropriately changing the embodiments described above without departing from the spirit of the present disclosure is also included in the technical scope of the present disclosure.

Moreover, it goes without saying that the embodiments described above are not limited to the above description and may be carried out by being combined appropriately so that no contradiction arises.

Furthermore, a program that operates in each apparatus in the embodiments is a program (a program that makes a computer function) which controls a CPU, for example, so as to implement the functions of the embodiments described above. In addition, information that is handled by these apparatuses is temporarily accumulated in a temporary memory unit (such as RAM) when being processed and then stored in various ROMs or a memory unit of an HDD, and reading and modification or writing are performed by the CPU as appropriate.

Here, a recording medium in which the program is stored may be any of the following media including, for example, semiconductor media (such as a ROM and a nonvolatile memory card), optical recording media and magneto-optical recording media (such as a digital versatile disc (DVD), a magneto-optical disc (MO), a mini disc (MD), a compact disc (CD), and a BD), and magnetic recording media (such as a magnetic tape and a flexible disc). Moreover, in addition to the functions of the above-described embodiments being implemented as a result of the loaded program being executed, the functions of the present disclosure are sometimes implemented as a result of processing being executed in cooperation with, for example, an operating system or another application program based on an instruction of the program.

Furthermore, for distribution to the market, the program may be stored in a portable recording medium for distribution or transferred to a server computer connected via a network such as the Internet. It goes without saying that, in this case, a memory unit of the server computer is also included in the present disclosure.

In addition, part or all of each apparatus in the embodiments described above may be implemented as large scale integration (LSI) which is typically an integrated circuit. The functional blocks of each apparatus may be individually implemented as a chip or part or all of the functional blocks may be integrally implemented as a chip. Moreover, the technique of circuit integration is not limited to LSI, and circuit integration may be implemented by a dedicated circuit or a general-purpose processor. Furthermore, it goes without saying that, when a circuit integration technology that can replace LSI comes into being by the advance of the semiconductor technology, an integrated circuit implemented by that technology can also be used.

The present disclosure contains subject matter related to that disclosed in Japanese Priority Patent Application JP 2016-89814 filed in the Japan Patent Office on Apr. 27, 2016, the entire contents of which are hereby incorporated by reference.

What is claimed is:

1. A content distribution apparatus that is connectable to a content display apparatus that can continuously display contents of a same attribute, the content distribution apparatus comprising:
a generating unit that generates a group of contents to be sent to the content display apparatus;
an attribute determining unit that determines, when a first content is newly added to the group, an attribute of the first content as an attribute of the group;
an adding unit that adds, when adding a second content to the group, the second content to the group if an attribute of the second content coincides with the attribute of the group; and
a sending unit that sends a content included in the group to the content display apparatus.

2. The content distribution apparatus according to claim 1, wherein
when adding the second content to the group, if the attribute of the second content does not coincide with the attribute of the group, the adding unit refuses to add the second content to the group.

3. The content distribution apparatus according to claim 2, wherein
when refusing addition of the second content to the group, the adding unit displays a message to an effect that addition of the second content to the group is refused.

4. The content distribution apparatus according to claim 1, wherein
when adding the second content to the group, if the attribute of the second content does not coincide with the attribute of the group, the adding unit generates a new group and adds the second content to the new group.

5. The content distribution apparatus according to claim 4, wherein
when adding the second content to the new group, the adding unit displays a message to an effect that the second content is added to the new group.

6. The content distribution apparatus according to claim 1, wherein
when adding the second content to the group, if the attribute of the second content does not coincide with the attribute of the group, the adding unit converts the attribute of the second content to the attribute of the group and adds the second content to the group.

7. The content distribution apparatus according to claim 6, wherein
the adding unit displays a message inquiring whether or not the attribute of the second content is converted to the attribute of the group and, in response to an instruction to convert the attribute of the second content to the attribute of the group, converts the attribute of the second content to the attribute of the group.

8. The content distribution apparatus according to claim 1, wherein
when adding the second content to the group, if the attribute of the second content does not coincide with the attribute of the group, the adding unit converts the attribute of the group to the attribute of the second content and adds the second content to the group.

9. The content distribution apparatus according to claim 8, wherein
the adding unit displays a message inquiring whether or not the attribute of the group is converted to the attribute of the second content and, in response to an instruction to convert the attribute of the group to the attribute of the second content, converts the attribute of the group to the attribute of the second content.

10. The content distribution apparatus according to claim 1, wherein
each of the attribute of the group and the attribute of the content is an attribute indicating at least one of a still image and video.

11. The content distribution apparatus according to claim 1, further comprising:
a screen display unit that displays a screen on which a group name of the group and the attribute of the group are indicated, the screen by which the content can be added to the group, wherein
when generating the group, the generating unit provides an indication to an effect that an attribute of the group is not yet determined, and
when determining the attribute of the first content as the attribute of the group, the attribute determining unit provides an indication of the attribute of the group.

12. A content distribution system comprising:
a content display apparatus that can continuously display contents of a same attribute; and
a content distribution apparatus that is connectable to the content display apparatus, wherein
the content distribution apparatus includes
a generating unit that generates a group of contents to be sent to the content display apparatus,
an attribute determining unit that determines, when a first content is newly added to the group, an attribute of the first content as an attribute of the group,
an adding unit that adds, when adding a second content to the group, the second content to the group if an attribute of the second content coincides with the attribute of the group, and
a sending unit that sends a content included in the group to the content display apparatus.

13. A non-transitory computer-readable medium that stores a computer program which, when executed by a computer connectable to a content display apparatus that can continuously display contents of a same attribute, cause the computer to:
generate a group of contents to be sent to the content display apparatus;
determine, when a first content is newly added to the group, an attribute of the first content as an attribute of the group;
add, when adding a second content to the group, the second content to the group if an attribute of the second content coincides with the attribute of the group; and
send a content included in the group to the content display apparatus.

14. An attribute control apparatus comprising:
a generating unit that generates a group of contents;
an attribute determining unit that determines, when a first content is newly added to the group, an attribute of the first content as an attribute of the group;
an adding unit that adds, when adding a second content to the group, the second content to the group if an attribute of the second content coincides with the attribute of the group; and
a sending unit that sends a content included in the group to an output apparatus.
